(19) United States
(12) Patent Application Publication
(10) Pub. No.: US 2024/0141689 A1
(43) Pub. Date: May 2, 2024

(54) Adjustable Invisible Strike Plate

(71) Applicant: Thomas Chenoweth, Fort Myers, FL (US)

(72) Inventor: Thomas Chenoweth, Fort Myers, FL (US)

(21) Appl. No.: 18/051,921

(22) Filed: Nov. 2, 2022

(51) Int. Cl. E05B 15/02

(52) U.S. Cl. CPC E05B 15/022

(57) ABSTRACT

A single member flat strike plate having a flat portion, a retraction portion, a flange portion, and a bendable means extending in the vertical direction on the back surface of the retraction portion. The flat portion ends near the front edge of the door jamb, the retraction portion is parallel to and outside of the front edge of the door jamb, the flange portion extends from the retraction portion to the meeting of the front surface of the door jamb and the inside edge of the front surface of the thin architrave. The object of the present invention is, if needed, an individual can easily, cleanly and straightly adjust the angle of the flange portion using a household pair of pliers such that the body of the flange portion and the open end of the flange portion is near the meeting of the front surface of the door jamb and the inside edge of the front surface of the thin architrave; thereby preventing accidents in which an individual's body or clothing gets caught when thin architrave surrounds the door jamb.

### BACKGROUND OF THE INVENTION

### Field of the Invention

The present invention relates to a door jamb strike plate, in particular, an apparatus for receiving an angled bolt of a door spring-loaded latch bolt mechanism.

### Brief Description of the Prior Art

In prior art strike plates, the open end of the lip portion of the strike plate as well as the body of the lip portion of the strike plate pose a physical hazard. Both the open end of the lip portion and the body of the lip portion project beyond the front edge of the door jamb and further project beyond the front edge of the architrave surrounding the door jamb. Typically, both the open end of the lip portion and the body of the lip portion protrude one-half of an inch beyond the front edge of the door jamb and one-quarter of an inch beyond the front edge of the architrave surrounding the door jamb. Both the protrusion of the open end of the lip portion and the protrusion of the body of the lip portion can cause accidents in which an individual's body or clothing gets caught.

### RELEVANT PRIOR ART

Komatsu, JPH08296353A, Nov. 12, 1996, herein after referred to as Komatsu, shows in Komatsu, FIG. 2 and FIG. 3, a single member flat strike plate 2 having a plurality of grooves 7 on the back surface of the flat portion of the strike plate 2. Komatsu, FIG. 2 and FIG. 3 show the plurality of grooves 7 is located on the back surface of the flat portion of the strike plate 2 between (a) the front edge of the collar plate 10 of the dust box 9 and (b) the intersection of the flat portion of the strike plate 2 and the lip portion 6 of the strike plate 2. Komatsu makes a claim the plurality of concave grooves is located on the lip portion side of the strike plate.

Komatsu, FIG. 4A and FIG. 4B show Komatsu working with thick architrave and working with thin architrave. Komatsu, FIG. 4A shows the strike plate working with thick architrave such that an individual installs the strike plate 2 without the need to bend the flat portion of the strike plate 2 because the open end of the lip portion 6 ends at the front edge of the thick architrave. In a different scenario, Komatsu, FIG. 4B shows the strike plate 2 working with thin architrave such that an individual installs the strike plate 2 with the need to bend the flat portion of the strike plate 2, using a hammer; the result is the open end of the lip portion 6 overlaps the front edge of the thin architrave surrounding the door jamb.

The object of the novel plurality of grooves 7 is to allow an individual to easily, cleanly and straightly bend the flat portion of the strike plate 2, using a hammer, such that the open end of the lip portion 2 overlaps the front edge of the thin architrave surrounding the door jamb; thereby, prevent accidents in which an individual's body or clothing gets caught.

### BRIEF SUMMARY OF THE INVENTION

The present invention is a single member flat strike plate having a flat portion, a retraction portion, a flange portion, and a bendable means on the back surface of the retraction portion. The flat portion of the strike plate ends at the front edge of the door jamb. The retraction portion, located at the meeting of the flat portion and the flange portion, is parallel to the front edge of the door jamb. The flange portion extends from the retraction portion to the meeting of the front surface of the door jamb and the inside edge of the front surface of the architrave surrounding the door jamb. The bendable means extending in the vertical direction, located on the back surface of the retraction portion, is parallel to the retraction portion, and is parallel to and outside of the front edge of the door jamb.

The bendable means, located on the back surface of the retraction portion, allows an individual, with a household pair of pliers, to easily, cleanly and straightly adjust the angle of the flange portion to properly install the strike plate on the door jamb. An individual can adjust, if necessary, the angle of the flange portion such that both the open end of the flange portion and the body of the flange portion are near the meeting of the front surface of the door jamb and the inside edge of the front surface of the architrave surrounding the door jamb. In other words, neither the open end of the flange portion nor the body of the flange portion protrudes the front edge of the architrave surrounding the door jamb. The object of the present invention is to prevent accidents in which an individual's body or clothing gets caught.

The bendable means for easily, cleanly and straightly adjusting the angle of the flange portion is a canal, cavity, concavity, crater, crenel, corrugation, crease, crimp, cut, cutting, dent, depression, dimple, dint, dip, ditch, embrasure, flute, fluting, furrow, gouge, groove, gutter, hollow, impression, incision, indentation, nick, notch, pit, pucker, rabbet, rut, scallop, score, scratch, sink, slit, trench, trough, or valley.

Further, the bendable means includes strike plate metal material typically used by the door hardware industry to construct interior door hardware and interior door strike plates installed, for example, on bedroom doors and door jambs, bathroom doors and door jambs, and closet doors and door jambs. Exterior door hardware and exterior door strike plates have a rigid property that is important to minimize the occurrence of unwanted entry, break-ins, and theft. Interior door hardware strike plates have a bendable property, for example, an individual can adjust the angle of the door hardware industry standard adjustable tab of the strike plate, if needed, in a range from eighty degrees to one hundred degrees with a household pair of pliers to eliminate door rattle. Likewise, with the bendable means of the above paragraph, an individual can easily, cleanly, and straightly adjust the angle of the present invention flange, if needed, in a range from eighty degrees to one hundred degrees with a household pair of pliers to fit a door jamb, properly receive the angled bolt of a door spring-loaded latch bolt mechanism, and, at the same time, prevent accidents in which an individual's body or clothing gets caught.

### DESCRIPTION OF THE PREFERRED EMBODIMENTS

One embodiment of the present invention is a single member flat strike plate constructed of metal or other suitable strike plate material and the strike plate having a flat portion, a retraction portion, a flange portion, and a bendable means. The flat portion ends at the front edge of the door jamb. The retraction portion is parallel the front edge of the door jamb. The flange portion extends from the retraction portion to the meeting of the front surface of the door jamb and the inside edge of the front surface of the thin architrave surrounding the door jamb. The bendable means, for example, an indentation, located on the back surface of the retraction portion, extending in the vertical direction, and is parallel to the front surface of the retraction portion. Further, the bendable means is parallel to and outside of the front edge of the door jamb. And, the body of the flange portion has a flat profile.

Another embodiment of the present invention is a single member flat strike plate constructed of metal or other suitable strike plate material and the strike plate having a flat portion, a retraction portion, a flange portion, and a bendable means. The flat portion ends at the front edge of the door jamb. The retraction portion is parallel to the front edge of the door jamb. The flange portion extends from the retraction portion to the meeting of the front surface of the door jamb and the inside edge of the front surface of the thin architrave surrounding the door jamb. The bendable means, for example, an indentation, located on the back surface of the retraction portion, extending in the vertical direction, and is parallel to the front surface of the retraction portion. Further, the bendable means is parallel to and outside of the front edge of the door jamb. And, the body of the flange portion has a curvature profile.

A further embodiment of the present invention is a single member flat strike plate constructed of metal or other suitable strike plate material and the strike plate having a flat portion, a retraction portion, a flange portion, and a bendable means. The flat portion ends at the front edge of the door jamb. The retraction portion is parallel to the front edge of the door jamb. The flange portion extends from the retraction portion to the meeting of the front surface of the door jamb and the inside edge of the front surface of the thin architrave surrounding the door jamb. The bendable means consisting of a plurality of bendable means, for example, a plurality of indentations, located on the back surface of the retraction portion, extending in the vertical direction, and is parallel to the front surface of the retraction portion. Further, the plurality of bendable means is parallel to and outside of the front edge of the door jamb.

The above and other objects, features and advantages of the present invention should become even more readily apparent to those skilled in the art upon a reading of the following detailed description in conjunction with the drawings wherein there is shown and described illustrative embodiments of the invention.

### Advantages of Invention Over Prior Art

The present invention single member flat strike plate having a flat portion, a retraction portion, a flange portion, and a bendable means on the back surface of the retraction portion allows an individual to easily, cleanly and straightly adjust the angle of the flange portion of the strike plate such that both the open end of the flange portion and the body of the flange portion are near the meeting of the front surface of the door jamb and the inside edge of the front surface of the thin architrave surrounding the door jamb. Thereby, the present invention prevents accidents in which an individual's body or clothing gets caught.

The present invention strike plate has a flat portion ending at the front edge of the door jamb to protect the door jamb from the angled bolt of the door spring-loaded latch bolt mechanism; thereby, prevents accidents in which an individual's body or clothing gets caught.

The present invention strike plate has a retraction portion that is parallel to the front edge of the door jamb; thereby, prevents accidents in which an individual's body or clothing gets caught.

The present invention strike plate has a body of the flange portion extending from the retraction portion of the strike plate to the meeting of the front surface of the door jamb and the inside edge of the front surface of the thin architrave surrounding the door jamb; thereby, prevents accidents in which an individual's body or clothing gets caught.

The present invention has a bendable means on the back surface of the retraction portion extending in the vertical direction to allow an individual, with a household pair of pliers, to easily, cleanly and straightly adjust the angle of the flange portion, if necessary, such that both the open end of the flange portion and the body of the flange portion are near the meeting of the front surface of the door jamb and the inside edge of the front surface of the thin architrave surrounding the door jamb. Thereby, the present invention prevents accidents in which an individual's body or clothing gets caught.

The present invention accommodates building industry standard thin architrave available at lumber yards and home improvement retail outlets that is prominently installed in houses and other buildings constructed from 1960 to the present and the foreseeable future. The thin architrave is available in the following popular sizes, for example, one-eighth of an inch thick front surface, five-thirty-seconds of an inch thick front surface, and three-sixteenths of an inch thick front surface.

### BRIEF DESCRIPTION OF DRAWINGS

In the following detailed description, reference will be made to the attached drawings in which:

FIG. 1A is a front perspective view of the strike plate.

FIG. 1B is an end perspective view of the strike plate.

FIG. 1C is a back perspective view of the strike plate.

FIGS. 2A through 211 are profile views of thin architrave and thick architrave.

FIG. 3 is a front perspective view of the angled bolt of the door spring-loaded latch bolt mechanism.

### DETAILED DESCRIPTION OF THE INVENTION

For purposes of describing the preferred embodiments, the terminology used in reference to the numbered accessories in the drawings is as follows:

### TERMINOLOGY

100 Strike plate
120 Flat portion of strike plate
122 Opening for receiving angled bolt of door spring-loaded latch bolt mechanism
124 Adjustable tab
126 Aperture for attaching flat portion of strike plate to door jamb
128 Interior surface of strike plate
130 Retraction portion of strike plate
132 Front surface of retraction portion
134 Back surface of retraction portion
136 Bendable means on back surface of retraction portion
140 Flange portion of strike plate
142 Open end of flange portion of strike plate
144 Body of flange portion of strike plate
200 Doorjamb
202 Profile surface of door jamb
204 Front surface of door jamb
210 Front edge of door jamb
230 Borehole for receiving angled bolt of door spring-loaded latch bolt mechanism
300 Door stop
400 Architrave
402 Profile surface of architrave
410 Front surface of architrave
420 Front edge of architrave
430 Inside edge of front surface of architrave
450 Back surface of architrave
500 Meeting of front surface of door jamb and inside edge of front surface of architrave
600 Dry wall
700 Stud
800 Door spring-loaded latch bolt mechanism
810 Angled bolt of door spring-loaded latch bolt mechanism

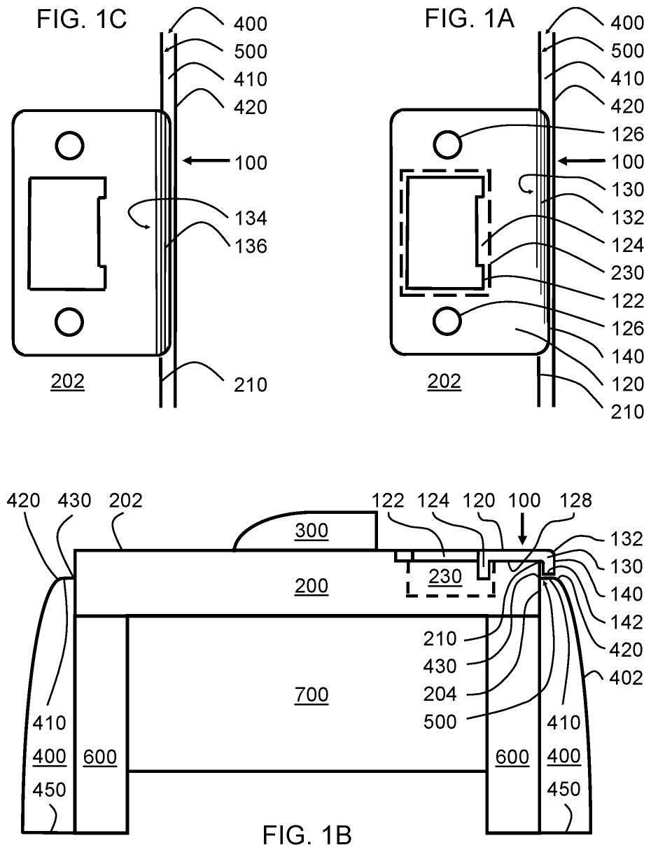

FIG. 1A shows the front perspective view of the present invention strike plate 100, a flat portion 120 of the strike plate 100, a retraction portion 130 of the strike plate 100, and a flange portion, 140 of the strike plate 100. The flat portion 120 of the strike plate 100 has an opening 122 for receiving the angled bolt of a door spring-loaded latch bolt mechanism, an adjustable tab 124, and a plurality of apertures 126 for attaching the flat portion 120 to the profile surface 202 door jamb 200 with fasteners. The flat portion 120 of the strike plate 100 ends at the front edge 210 of the door jamb 200. The retraction portion 130 of the strike plate 100 is parallel to the front edge 210 of the door jamb 200. The retraction portion 130 of the latch strike 100 has a front surface 132 that retracts FIG. 3 the angled bolt 810 of a door spring-loaded latch bolt mechanism 800. FIG. 1C, the retraction portion 130 has a back surface 134 that is parallel to and outside of the front edge 210 of the door jamb 200. The retraction portion 130 is located FIG. 1B at the meeting 500 of the flat portion 120 of the strike plate 100 and the flange portion 140 of the strike plate 100. The door jamb 200 has a borehole 230 for receiving FIG. 3 the angled bolt 810 of a door spring-loaded latch bolt mechanism 800. FIG. 1A also shows the front edge 420 and the front surface 410 of the architrave 400.

FIG. 1B shows the end perspective view of the present invention strike plate 100, a flat portion 120 of the strike plate 100, a retraction portion 130 of the strike plate 100, a flange portion 140 of the strike plate 100, and FIG. 1C a bendable means 136 on the back surface 134 of the retraction portion 130 of the strike plate 100. The flat portion 120 of the strike plate 100 has an opening 122 for receiving FIG. 3 the angled bolt 810 of a door spring-loaded latch bolt mechanism 800, and an adjustable tab 124. The flat portion 120 of the strike plate 100 ends at the front edge 210 of the door jamb 200. The retraction portion 130 of the strike plate 100 is parallel to the front edge 210 of the door jamb 200. The retraction portion 130 has a front surface 132 that retracts FIG. 3 the angled bolt 810 of a door spring-loaded latch bolt mechanism 800. The retraction portion 130 has FIG. 1C a back surface 134 that is parallel and outside of the front edge 210 of the door jamb 200. The retraction portion 130 is located at the meeting of the flat portion 120 of the strike plate 100 and the flange portion 140 of the strike plate 100. FIG. 1C the back surface 134 of the retraction portion 130 has a bendable means 136 that is parallel to the front surface 132 of the retraction portion 130. FIG. 1C the bendable means 136 is parallel to and outside of the front edge 210 of the door jamb 200. The flange portion 140 extends from the retraction portion 130 to the meeting 500 of the front surface 204 of the door jamb 200 and the inside edge 430 of the front surface 410 of the architrave 400. The open end 142 of the flange portion 140 is near the meeting 500 of the front surface 204 of the door jamb 200 and the inside edge 430 of the front surface 410 of the architrave 400 surrounding the door jamb 200. The door jamb 200 has a borehole 230 for receiving FIG. 3 the angled bolt 810 of a door spring-loaded latch bolt mechanism 800. Attached to the profile surface 202 of the door jamb 200 is a door stop 300. The architrave 400 has a front surface 410 and a back surface 450. The front surface 410 has a front edge 420 and an inside edge 430. FIG. 1B also shows the dry wall 600 and a stud 700.

FIG. 1C shows a back perspective view of the present invention strike plate 100, the back surface 134 of the retraction portion 130, and the bendable means 136 extending in the vertical direction on the back surface 134 of the retraction portion 130. FIG. 1C also shows the bendable means 136 is parallel to the back surface 134 of the retraction portion 130 and the bendable means 136 is parallel and outside of the front edge 210 of the door jamb 200. Further, FIG. 1C shows the profile surface 202 of the door jamb 200; the front surface 410 and the front edge 420 of the architrave 400; and the meeting 500 FIG. 1B of the front surface 204 of the door jamb 200 and the interior edge 430 of the front surface 410 of the architrave 400.

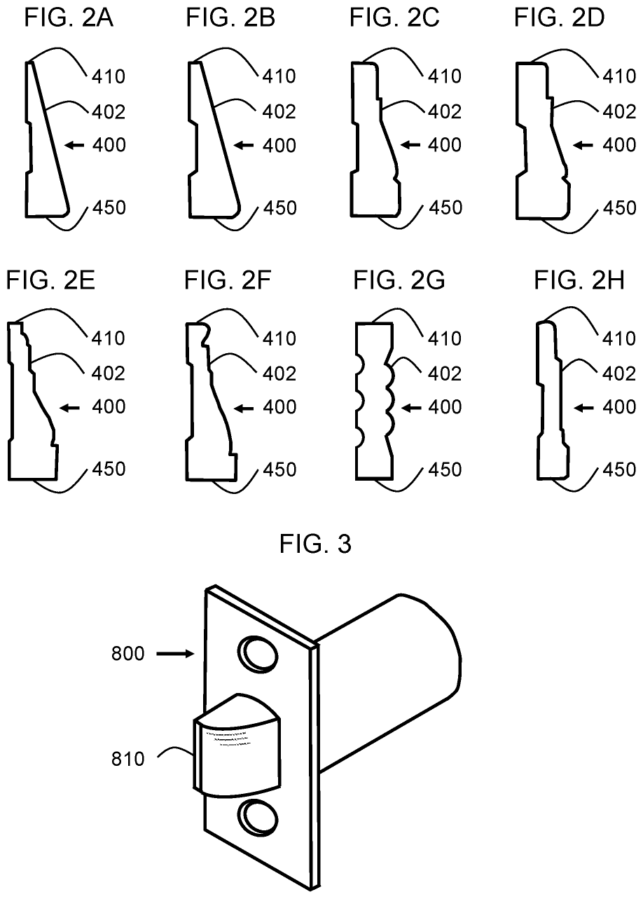

FIGS. 2A through 211 show profile views of standard sizes of thin architrave and standard sizes of thick architrave. FIG. 2A and FIG. 2B show standard sizes of thin architrave having a one-eighth of an inch thick front surface 410 and a three-sixteenths of an inch thick front surface 410, respectively. FIGS. 2C through 211 show standard sizes of thick architrave having a one-quarter of an inch thick front surface 410, a five-sixteenths of an inch thick front surface 410, a three-eighths of an inch thick front surface 410, and a one-half of an inch thick front surface 410. FIGS. 2A through 211 also show the profile surface 402 and the back surface 450 of the architrave 400.

FIG. 3 shows a front perspective view of an angled bolt 810 of a door spring-loaded latch bolt mechanism 800.

The foregoing description and accompanying figures illustrate the principles, preferred embodiments, and modes of operation of the invention. However, the invention should not be construed as being limited to the particular embodiments described above. Additional variations of the embodiments discussed above will be appreciated by those skilled in the art.

Therefore, the above-described embodiments should be regarded as illustrative rather than restrictive. Accordingly, it should be appreciated that variations of those embodiments can be made by those skilled in the art without departing from the scope of the invention as defined by the following claims.

Having thus described my invention, I claim:

1. A strike plate consisting of a single member flat strike plate and comprising:
a flat portion;
a retraction portion;
a flange portion;
said flat portion having an opening for receiving an angled bolt of a door spring-loaded latch bolt mechanism;
said flat portion having an adjustable tab;
said flat portion having a plurality of apertures for attaching said flat portion to a door jamb;
an interior surface of said flat portion ends at a front edge of the door jamb;
said retraction portion is near the front edge of the door jamb;
said retraction portion is parallel to the front edge of the door jamb;
said retraction portion is outside of the front edge of the door jamb;
said retraction portion is at a meeting of said flat portion and said flange portion;
said retraction portion having a front surface retracting the angled bolt of the door spring-loaded latch bolt mechanism;
said flange portion having a body extending from said retraction portion towards a meeting of a front surface of the door jamb and an inside edge of a front surface of an architrave surrounding the door jamb;
said flange portion having an open end near the meeting of the front surface of the door jamb and the inside edge of the front surface of the architrave surrounding the door jamb;
said retraction portion having a bendable means extending in a vertical direction on a back surface of said retraction portion;
said bendable means is parallel to said front surface of said retraction portion;
said bendable means is parallel to the front edge of the door jamb; and
said bendable means is outside of the front edge of the door jamb.

2. A strike plate consisting of a single member flat strike plate and comprising:
a retraction portion;
a flange portion;
said flat portion having an opening for receiving an angled bolt of a door spring-loaded latch bolt mechanism;
said flat portion having an adjustable tab;
said flat portion having a plurality of apertures for attaching said flat portion to a door jamb;
an interior surface of said flat portion ends at a front edge of the door jamb;
said retraction portion is near the front edge of the door jamb;
said retraction portion is parallel to the front edge of the door jamb;
said retraction portion is outside of the front edge of the door jamb;
said retraction portion is at a meeting of said flat portion and said flange portion;
said retraction portion having a front surface retracting the angled bolt of the door spring-loaded latch bolt mechanism;
said flange portion having a body extending from said retraction portion towards a meeting of a front surface of the door jamb and an inside edge of a front surface of an architrave surrounding the door jamb;
said flange portion having an open end ending near the meeting of the front surface of the door jamb and the inside edge of the front surface of the architrave surrounding the door jamb;
said retraction portion having a bendable means extending in a vertical direction on a back surface of said retraction portion;
said bendable means is parallel to said front surface of said retraction portion;
said bendable means is parallel to the front edge of the door jamb; and
said bendable means is outside of the front edge of the door jamb.

3. A strike plate consisting of a single member flat strike plate and comprising:
a retraction portion;
a flange portion;
said flat portion having an opening for receiving an angled bolt of a door spring-loaded latch bolt mechanism;
said flat portion having an adjustable tab;
said flat portion having a plurality of apertures for attaching said flat portion to a door jamb;
an interior surface of said flat portion ends at a front edge of the door jamb;
said retraction portion is near the front edge of the door jamb;
said retraction portion is parallel to the front edge of the door jamb;
said retraction portion is outside of the front edge of the door jamb;
said retraction portion is at a meeting of said flat portion and said flange portion;
said retraction portion having a front surface retracting the angled bolt of the door spring-loaded latch bolt mechanism;
said flange portion having a body extending from said retraction portion towards a meeting of a front surface of the door jamb and an inside edge of a front surface of an architrave surrounding the door jamb;
said flange portion having an open end near the meeting of the front surface of the door jamb and the inside edge of the front surface of the architrave surrounding the door jamb;
said retraction portion having a plurality of bendable means extending in a vertical direction on a back surface of said retraction portion;
said plurality of bendable means is parallel to said front surface of said retraction portion;
said plurality of bendable means is parallel to the front edge of the door jamb; and
said plurality of bendable means is outside of the front edge of the door jamb.

4. A strike plate consisting of a single member flat strike plate and comprising:
a retraction portion;
a flange portion;
said flat portion having an opening for receiving an angled bolt of a door spring-loaded latch bolt mechanism;
said flat portion having an adjustable tab;
said flat portion having a plurality of apertures for attaching said flat portion to a door jamb;
an interior surface of said flat portion ends at a front edge of the door jamb;
said retraction portion is near the front edge of the door jamb;
said retraction portion is parallel to the front edge of the door jamb;
said retraction portion is outside of the front edge of the door jamb;
said retraction portion is at a meeting of said flat portion and said flange portion;
said retraction portion having a front surface retracting the angled bolt of the door spring-loaded latch bolt mechanism;
said flange portion having a body extending from said retraction portion towards a meeting of a front surface of the door jamb and an inside edge of a front surface of an architrave surrounding the door jamb;
said flange portion having an open end ending near the meeting of the front surface of the door jamb and the inside edge of the front surface of the architrave surrounding the door jamb;
said retraction portion having a plurality of bendable means extending in a vertical direction on a back surface of said retraction portion;
said plurality of bendable means is parallel to said front surface of said retraction portion;
said plurality of bendable means is parallel to the front edge of the door jamb; and
said plurality of bendable means is outside of the front edge of the door jamb.
